(19) United States
(12) Patent Application Publication
(10) Pub. No.: US 2006/0200644 A1
(43) Pub. Date: Sep. 7, 2006

(54) Storage medium for storing processing mode specifying information conversion program and processing mode specifying information conversion method

(75) Inventors: Kei Asada, Kawasaki-shi (JP); Hirofumi Ogawa, Kawasaki-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/223,933

(22) Filed: Sep. 13, 2005

(30) Foreign Application Priority Data
Mar. 4, 2005 (JP) 2005-87310

(51) Int. Cl. G06F 12/00

(52) U.S. Cl. 711/205

(57) ABSTRACT

The present invention provides a processing mode specifying information conversion method. The method includes: acquiring first information for specifying a processing mode of a first process in a first program by acquiring means, converting the acquired first information into second information for specifying a processing mode of a second process in a second program, which is different from the first program in a method of expressing information for specifying a processing mode, by converting means, and setting the converted second information by setting means.

### CROSS-REFERENCE TO RELATED APPLICATIONS

This application claims priority under 35USC 119 from Japanese Patent Application No. 20054087310, the disclosure of which is incorporated by reference herein.

### BACKGROUND OF THE INVENTION

1. Field of the Invention

The present invention relates to a storage medium for storing a processing mode specifying information conversion program and a processing mode specifying information conversion method, and more particularly to a storage medium storing a processing mode specifying information conversion program for specifying a processing mode of a process in a predetermined program, and a processing mode specifying information conversion method.

2. Description of the Related Art

Recently, printer functions of office printers and hybrid machines are advanced to be common and uniform, and applicable functions are not so much different among different devices. Printer drivers for operating printers include functions almost common to drivers, and many setting items for original functions of individual printer drivers rather than the device original functions.

For example, magnification/reduction, N-up, pamphlet, and color correction are own functions of a printer driver, and color/monochromatic specification, both-side printing, hand feeding, and user account are device functions, but they are common functions in recent office printers. These functions can be stored in a default state related to logical printer (printer icon in the case of Windows OS) for the convenience of users in the principal OS. Accordingly, plural logical printers can be prepared in one device (printer), and may be used according to applications.

On the other hand, setting of network or setting of device options (memory, tray composition, finisher composition) not related to user's will nor the intention can be automatically acquired or set via network.

In this circumstance, in the case of change of mode of the printer being used due to renewal of rental contract, there is a problem when installing a printer driver for a new model. It is supposed that the printer driver for the conventional print and the printer driver for the new printer are set in different devices, and the setting cannot be handed over (at least not supported by the OS). For this reason, if plural logical printers are prepared for different applications, it is required to set again by creating a new logical printer for a new printer.

### SUMMARY OF THE INVENTION

The present invention has been made in view of the above circumstances and provides a storage medium for storing processing mode specifying information conversion program and a processing mode specifying information conversion method.

According to a first aspect of the present invention, it is provided a storage medium, on which a processing mode specifying information conversion program for causing a computer to execute processing mode specifying information conversion process is stored. The processing mode specifying information conversion process includes (a) acquiring first information for specifying a processing mode of a first process in a first program, (b) converting the acquired first information into second information for specifying a processing mode of a second process in a second program, which is different from the first program in a method of expressing information for specifying a processing mode, and (c) setting the converted second information.

According to a second aspect of the present invention, it is provided a storage medium, on which a processing mode specifying information conversion program for causing a computer to execute a processing mode specifying information conversion process is stored. The processing mode specifying information conversion process includes (a) acquiring first information for specifying respective plural processing modes of a first printing process in a first printer driver program, (b) converting the acquired first information into second information for specifying a processing mode of a second printing process in a second printer driver program, which is different from the first printer driver program in a method of expressing information for specifying a processing mode, and (c) setting the converted second information.

According to a third aspect of the present invention, it is provided an information processing apparatus connected to a process execution device and having a storage medium. The storage medium stores a processing mode specifying information conversion program for causing a computer to execute a processing mode specifying information conversion process. The processing mode specifying information conversion process includes (a) acquiring first information for specifying a processing mode of a first process in a first program by acquiring means, (b) converting the acquired first information into second information for specifying a processing mode of a second process in a second program, which is different from the first proven in a method of expressing information for specifying a processing mode, by converting means, and (c) setting the converted second information by setting means.

According to a fourth aspect of the present invention, it is provided an information processing apparatus connected to a process execution device and having a storage medium. The storage medium stores a processing mode specifying information conversion program for causing a computer to execute a processing mode specifying information conversion process. The processing mode specifying information conversion process includes (a) acquiring first information for specifying respective plural processing modes of a first printing process in a first printer driver program by acquiring means, (b) converting the acquired first information into second information for specifying processing mode of a second printing process in a second printer driver program, which is different from the first printer driver program in a method of expressing information for specifying processing mode, by converting means, and (c) setting the converted second information by setting means.

According to a fifth aspect of the present invention, it is provided a process execution device having a storage medium. The storage medium stores a processing mode specifying information conversion program for causing a computer to execute a processing mode specifying information conversion process, and the processing mode specifying information conversion process includes (a) acquiring first information for specifying respective plural processing modes of a first printing process in a first printer driver program by acquiring means, (b) converting the acquired first information into second information for specifying a processing mode of a second printing process in a second printer driver program, which is different from the first printer driver program in a method of expressing information for specifying a processing mode, by converting means, and (c) setting the converted second information by setting means.

According to a sixth aspect of the present invention, it is provided that a processing mode specifying information conversion method. The method comprises acquiring first information for specifying a processing mode of a first process in a first program; converting the acquired first information into second information for specifying a processing mode of a second process in a second program, which is different from the first program in a method of expressing information for specifying a processing mode; and setting the converted second information.

According to a seventh aspect of the present invention, it is provided that a processing mode specifying information conversion method. The method comprises acquiring fit information for specifying respective plural processing modes of a first printing process in a fit printer driver program converting the acquired first information into second information for specifying a processing mode of a second printing process in a second printer driver program, which is different from the first printer driver program in a method of expressing information for specifying a processing mode; and setting the converted second information.

According to the present invention, in a second program different from a first program in a method of expressing information for specifying a processing mode, the processing mode specified in the first program can be applied.

### BRIEF DESCRIPTION OF THE DRAWINGS

Embodiments of the present invention will be described in detail based on the following figures, wherein:

FIG. 1 is a block diagram of prim system having printers and clients;

FIG. 2 is a block diagram of a client;

FIG. 3 is a diagram showing composition of former setting management method data (first information);

FIG. 4 is a diagram showing composition of new setting management method data (second information);

FIG. 5 is a diagram of analysis data for analyzing former setting management method data for specifying the processing mode of process in former printer driver (first program);

FIG. 6 is a diagram of analysis data for analyzing new setting management method data for specifying the processing mode of process in new printer driver (second program);

FIG. 7 is a flowchart of processing mode specifying program conversion program;

FIG. 8 is a flowchart of sub-program of process at step 58 in FIG. 7;

FIG. 9 is a diagram of setting contents of new setting management data when processing mode of process in new printer driver is not found in processing mode in former printer driver;

FIG. 10 is a diagram of use of logical printer name directly in new printer driver when former setting management data in former printer driver is converted new setting management method data in new printer driver;

FIG. 11 is a diagram of analysis data for analyzing information for specifying processing mode of process in third program;

FIG. 12 is a diagram of setting contents of information when processing mode of process in third program is not found in processing mode in second program;

FIG. 13 is a diagram of conversion table of former setting management method data and new setting management method data; and

FIG. 14 is a flowchart of sub-program of process at step 58 in FIG. 7 in a modified example.

### DETAILED DESCRIPTION OF THE INVENTION

Referring now to the accompanied drawings, prefer embodiments of the present invention are specifically described below.

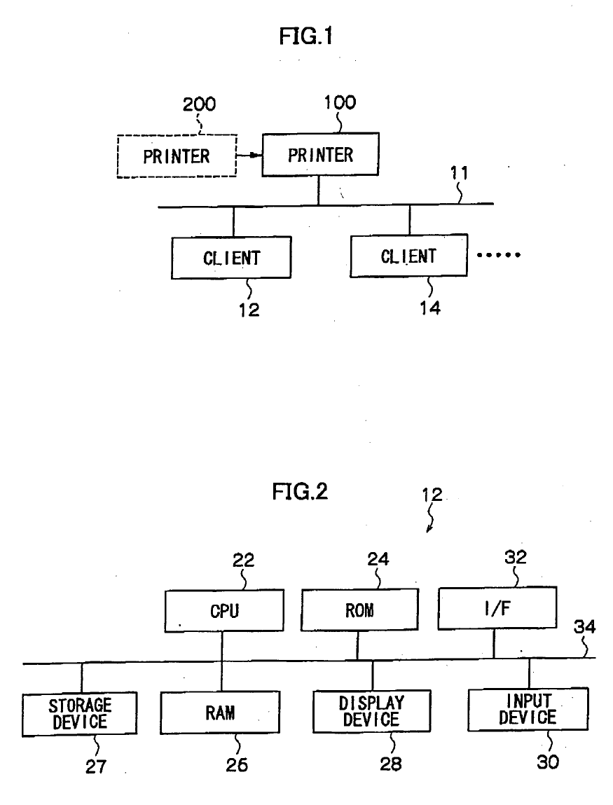

As shown in FIG. 1, a print system as process execution device of an embodiment comprises a printer 100, and plural clients 12, 14, . . . as documentation devices connected to the printer 100 by way of a network 11. Here, the plural clients 12, 14, . . . are identical in configuration, and the client 12 is explained as a representative example.

As shown in FIG. 2, the client 12 comprises CPU 22, ROM 24, RAM 26, storage device (hard disk, etc.) 27 as storage medium, display device 28 as display means, input device 30 consisting of mouse, keyboard, and input unit for reading and receiving programs and others from flexible disk as storage means, and interface (I/F) 32 connected to the printer 100 by way of the network 11, which are mutually connected to compose the client 12.

The storage device 27 stores, among others, a document creating program for creating documents, a spread sheet program for calculating, a printer driver program as a first program for specifying a processing mode of a printing process (first process) by the printer 100, and a processing mode specifying information conversion program for converting the information (former setting management method data; first information) for specifying the processing mode in the first program into information (new setting management method data; second information) for specifying a processing mode in a second program described below. As mentioned below, the second program is input by way of the input device 30 and stored in the storage device 27.

In the embodiment, as described below, the setting management method data specifying the processing mode in first program is converted into the setting management method data specifying the processing mode in second program, and this conversion makes use of related information showing relation between processing mode of first process in first program and processing mode of second process in second program, more specifically, in this embodiment, identification information predetermined in processing mode common to the processing mode of first process and the processing mode of second process.

This identification information (related information) or intermediate format code is explained.

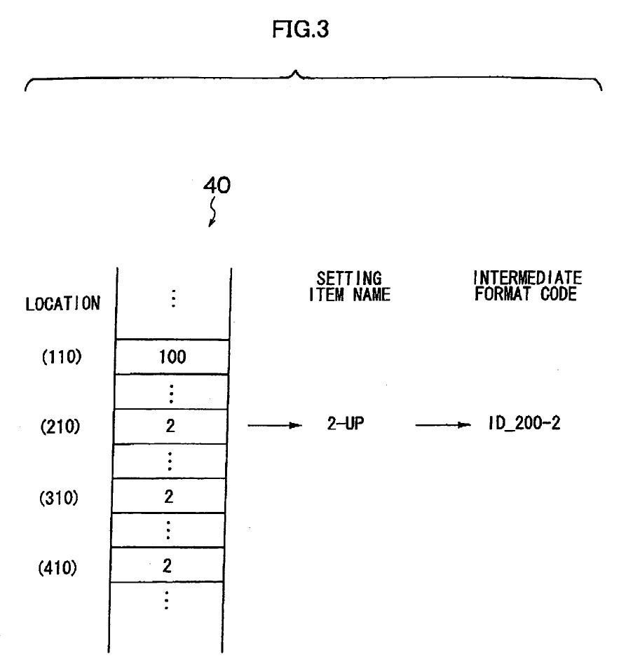

Setting management method data 40 sling the processing mode in first program specifics, as shown in FIG. 3, information specifying the setting item (processing mode) in a predetermined position. For example, when 100 is set at 110-th byte position, this is to specify monochromatic printing. When 2 is set at 210-th byte position, this is to specify 2-up printing. Similarly, when 1 or 3 is set at 210-th byte position, this is to specify 1-up printing or 4-up printing respectively. Thus, the setting management method data 40 specifying the processing mode in first program is to show which processing mode is specified depending on the value set in the predetermined position.

As shown in FIG. 1, suppose a printer 200 of new model is connected to the network 11 in place of the printer 100. The first program is to specify the processing mode of process of former printer 100 (printer driver program), and is applicable to a merely updated version of former printer 100, but cannot specify the processing mode of process of new printer 200, which is different in model. Therefore, when new printer 200 is connected to the network 11, a second program printer driver program) is needed for specifying the processing mode of process of new printer 200.

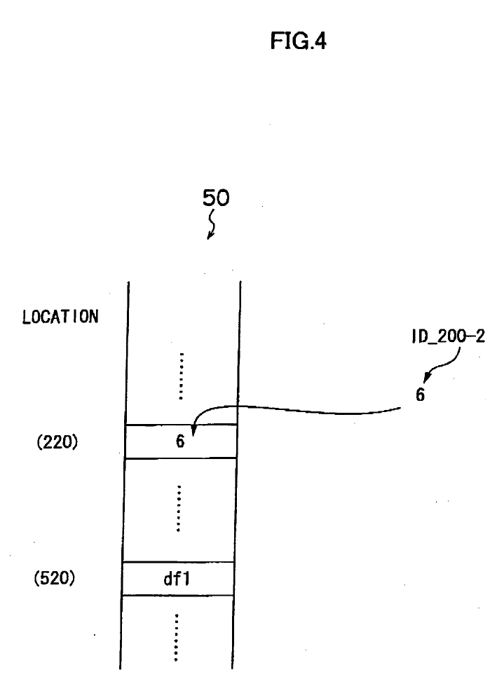

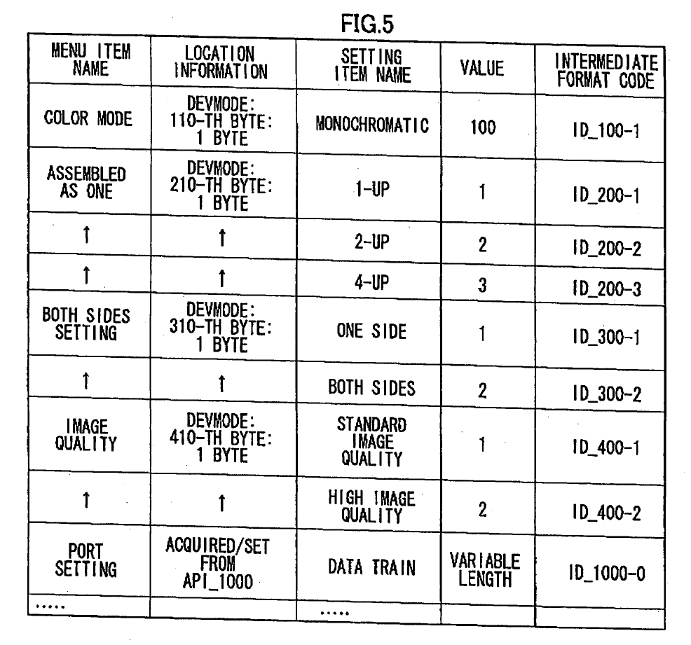

The second program is different from the first process in the method of expressing the information specifying the processing mode. For example, as shown in FIG. 4, in setting management method data 50 specifying the processing mode in second program, when 6 is set at 220-th byte position, this is to specify 2-up printing. That is, when specifying 2-up printing, in the first program, 2 is set at 210-th byte position, but in the second program, 6 is set at 220-th byte position. Thus, the second program is different from the first program in: the method of expressing information for specifying the processing mode, and in order to execute processing by specifying the processing mode in the printer 200, the setting management method data 50 (see FIG. 4) conforming to the second program is necessary.

When the processing mode set in the first program is directly used in the second program, the setting management method data in first program must be converted for second program, and set as setting management method data in second program. In this case, it is troublesome for the user to set the setting management method data in second program individually.

In the embodiment, therefore, the setting management method data for specifying the processing mode in first program is automatically converted into setting management method data for specifying processing mode in second program. Hence, in the embodiment, this conversion is realized by adding an intermediate format code to the processing mode common to the processing mode of first process and the processing mode of second process.

FIG. 5 shows analysis data of setting management method data in first program. As shown in FIG. 5, this analysis data shows which processing mode is specified in first program, wherever the position may be or whatever the value may be. As mentioned above, for example, when 100 is set at 110-th byte position, it is recognized that this is to specify monochromatic printing. When 2 is set at 210-th byte position, it is recognized that this is to specify 2-up printing.

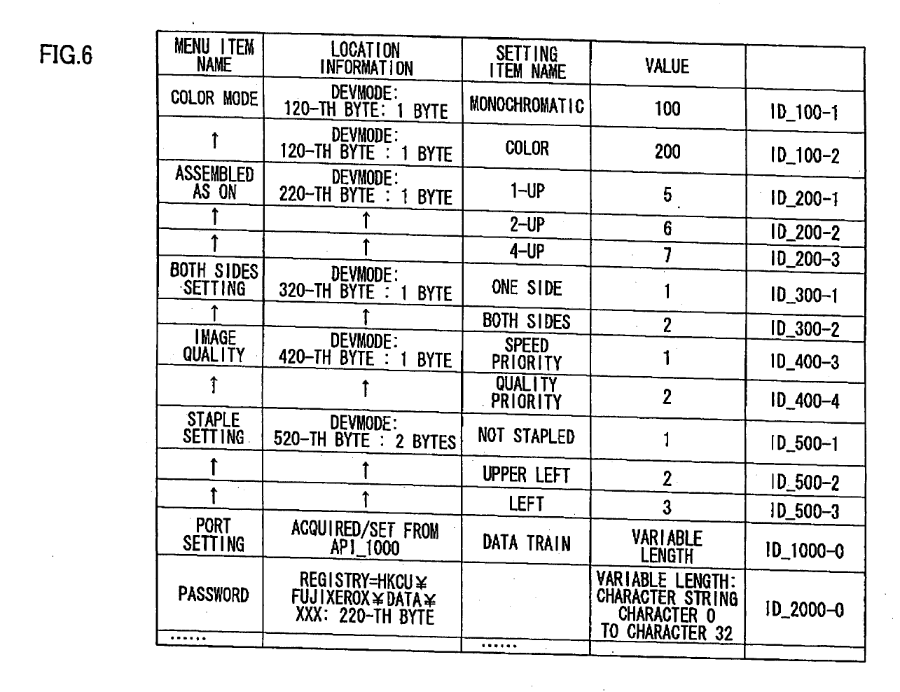

On the other hand, FIG. 6 analysis data of setting management method data in second program. As shown in FIG. 6, this analysis data shows which processing mode is specified in second program, wherever the position may be or whatever the value may be. As mentioned above, for example, when 6 is set at 220-th byte position, it is recognized that his is to specify 2-up printing.

Between the first program and second program, common processing mode can be set, such as monochromatic printing or 2-up printing. In each analysis data, therefore, the processing mode common to first program and second program is provided with same intermediate format code for conversion. For example, in 2-up printing, intermediate format code ID_{—}200-2 is provided.

Therefore, as shown in FIG. 3, in the setting management method data 40, when 2 is set at 210-th byte position, setting item name (2-up, etc.) can be recognized from the analysis data (see FIG. 5), and position and value of setting management method data 40, and from this setting item name, the intermediate format can be identified (ID-200-2, etc.). As the processing mode of process of new printer 200, to set the processing mode same as processing mode of former printer 100, in the setting management method data 50 in second program, the corresponding value (6) must be acquired from the intermediate format code (ID-200-2, etc.) and set in specified position (220-th byte position) by using the analysis data (see FIG. 6) of setting management method data 50 in second program as shown in FIG. 4. That is, it requires the processing mode specifying information conversion program for converting the setting management method data 40 in first program for second program, and setting in setting management method data 50.

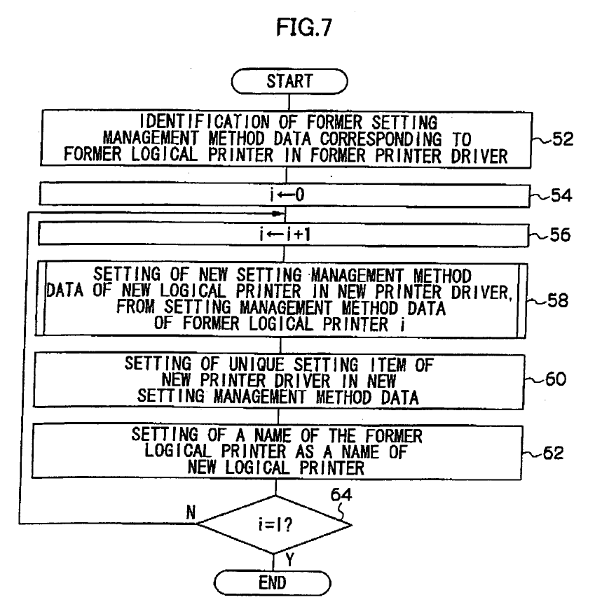

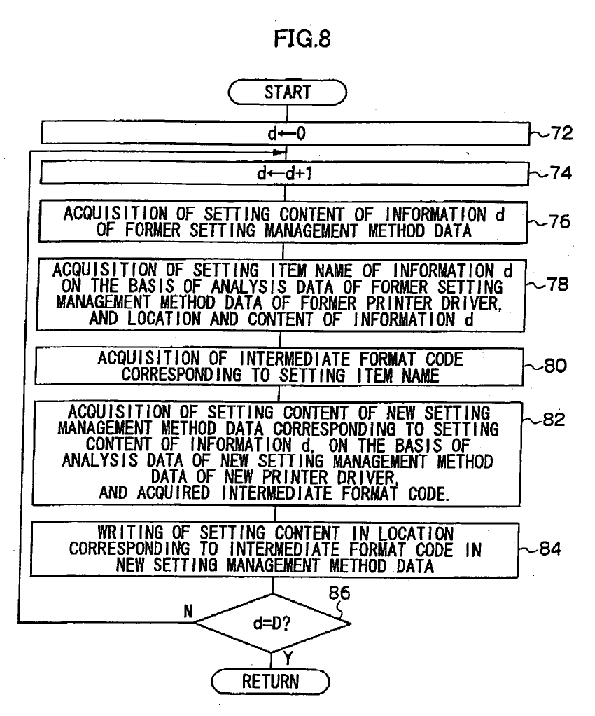

The processing mode specifying information conversion program for converting the setting management method data 40 in first program for send program and setting in setting management method data 50 is explained by referring to FIG. 7.

Herein, the first program is called as a former printer driver, and the second program is called as a new printer driver. The setting management method data in former printer driver is called former setting management method data, and the setting management method data in new printer driver is called new setting management method data.

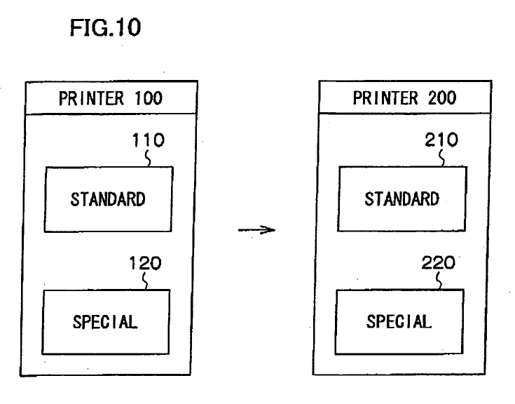

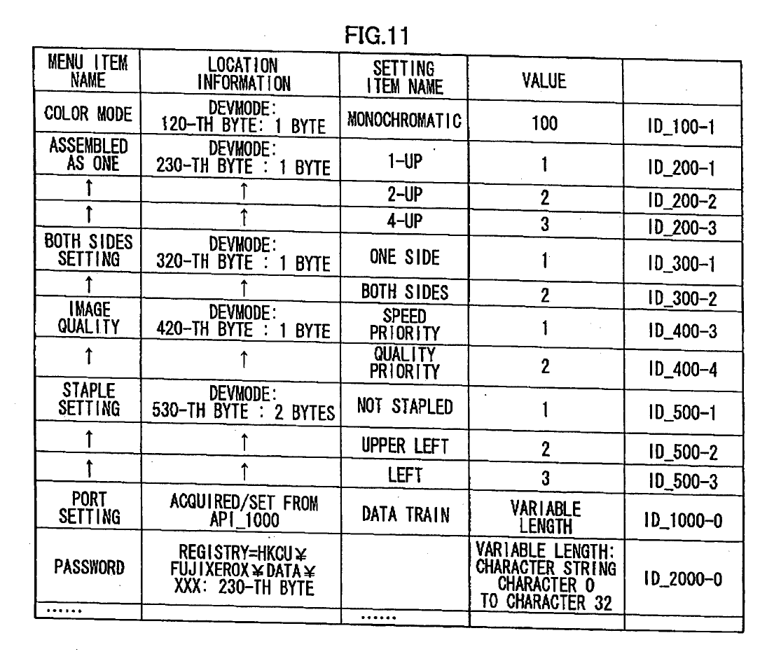

In this embodiment, in the former printer driver, plural pieces of setting management method data can be set, and further as shown in FIG. 10, logical printers 110, 120 are used as identification information for identifying plural pieces of setting management method data individually, and plural pieces of setting management method data can be managed by using the logical printers 110, 120.

The user selects either logical printer 10 or 120 when printing by the printer, and the printer 100 executes the printing process. It is hence necessary to convert and set the setting management method data in every logical printer.

Thus, at step 52, the former setting management method data corresponding to the former logical printer in the former printer driver is identified, and at step 54, variable i for identifying each former logical printer is initialized to 0, and at step 56, variable i is incremented by 1.

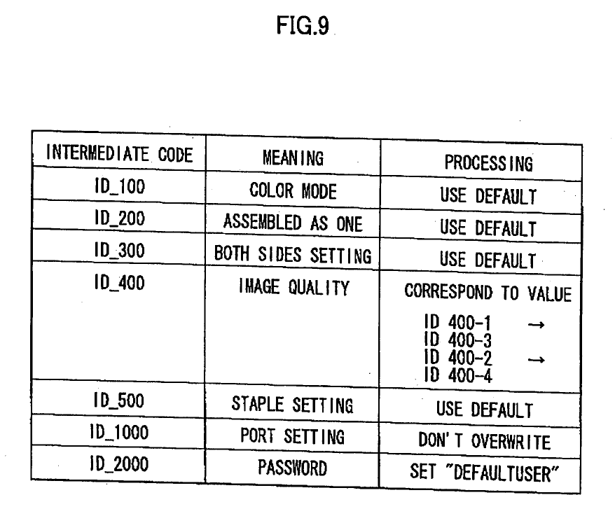

At step 58, from the setting management method data of former logical printer i, new setting management method data of new logical printer in new printer driver is set. Herein, process at step 58 is more specifically described below by referring to FIG. 8.

At step 72 in FIG. 8, variable d for identifying each information of setting management method data in former logical printer i is initialized, and variable d is incremented by 1 at step 74, and setting content of information d of former setting management method data is acquired at step 76 (acquiring means).

At subsequent steps 78 to 82, information of former setting management method data is converted into information of now setting management method data (convening means). That is, first at step 78, setting item name of information d is acquired on the basis of analysis data (see FIG. 5) of former setting management method data of former printer driver, and position and content of information d. For example, setting item name of 2-up is acquired on the basis of analysis data (see FIG. 5) and the value (2) set at 210-th byte position as shown above.

At step 80, intermediate format code (ID_{—}200-2, etc.) corresponding to the acquired setting item name (2-up) is acquired.

At step 82, setting content of new setting management method data corresponding to setting content of information d is acquired on the basis of analysis data (see FIG. 6) of new setting management method data 50 of new printer driver, and acquired intermediate format code (ID_{—}200-2, etc.). That is, the corresponding value (6) is acquired from the analysis data (see FIG. 6) of new setting management method data 50 in new printer driver and intermediate format code (ID_{—}200-2, etc.).

At step 84 (setting means), setting content is written into a position (predetermined position) corresponding to intermediate format code in new setting management method data. That is, as shown in FIG. 6, the position corresponding to the intermediate format code (ID_{—}200-2) is 220-th byte position, as known from the analysis data (see FIG. 6), and the acquired value (6) is set at 220-th byte position as shown in FIG. 6.

At step 86, by judging whether or not variable d is equal to the total number D of pieces of information of setting management method data of former logical printer i, it is judged whether all information of former setting management method data has been converted to information of new setting management method data or not. If variable d is not equal to the total number D of pieces of information of setting management method data of former logical printer i since the all information of former setting management method data is not converted into information of new setting management method data, the subsequent process (steps 74 to 86) is executed by going back to step 74 to convert the remaining information.

On the other hand, when variable d is equal to the total number D of pieces of information of setting management method data of former logical printer i, all information of former setting management method data has been converted into information of new setting management method data, and the process returns to step 60 in FIG. 7.

Here, the above explanation is intended to set by converting the information of processing mode common to processing mode specified by former setting management method data, and new setting management method data, but new setting management method data may be unique and not common. In such a case, at step 60, a setting item unique for new printer driver is set in new setting management method data.

What content should be set in the setting item unique for new printer driver cannot be judged from the content of former printer driver. As countermeasures, various methods are considered, including a first method of setting uniformly in predetermined content, a second method of inquiring the user to be set individually by the user, and a third method of ignoring this unique setting item, and any method is applicable. The first method is employed in this embodiment, that is, uniform setting in predetermined content. That is, in FIG. 9, the setting content in this case is stored preliminarily. In relation between first program and second program, since the first program does not have staple setting or password setting in the second program, and predetermined content is set in this case. For example, as staple setting, a value expressing two positions is set.

At next step 62, the name of former logical printer is set as name of new logical printer. For example, when the content of former logical printer 110 is converted and set as shown in FIG. 10, as the name of new logical printer, “standard” is set which is the name of former logical printer 110. However, it is not limited to such automatic setting of name of former logical printer as name of new logical printer, the user may be allowed to set individually.

At step 64, it is judged whether or not variable i for identifying former logical printers is equal to total number I of former logical printers. When it is judged that variable i for identifying former logical printers is not equal to total number I of former logical printers, it means some of the logical printers are not converted nor set yet, and going back to step 56, the subsequent process (steps 56 to 64) is executed. On the other hand, when it is judged that variable i for identifying former logical printers is equal to total number I of former logical printers, it means all logical printers are processed completely, and this program is terminated.

The analysis data (FIG. 5 and FIG. 6) are contained in the second program.

As described above, since the setting management method data in former printer driver is set by converting into new setting management method data i new printer driver different from the former printer driver in the method of expressing information for specifying processing mode, the processing mode in the former prier driver can be applied also in the new printer driver.

It is therefore easier to transfer to a different model. That is, if a new printer is installed, it can be immediately ready and used in printing at the client side without requiring any installation work. Secondly, the accustomed and familiar se can be used as it is. In the environment of using plural devices (printers), each printer can be used in the same setting. Thirdly, even in different printers, logical printers of same setting can be created.

The embodiment explained so far mainly relates to a case of converting former setting management method data in former printer driver into new setting management method data in new printer driver different from former printer driver in the method of expressing information specifying processing mode, and the invention is not limited to this embodiment, but may be similarly executed in a case of connecting a further new printer in place of the printer 200.

That is, FIG. 11 shows analysis data for analyzing information specifying processing mode of process in a further new printer driver (third program). As shown in FIG. 11, a same intermediate format code is added to the processing mode common to second program. For example, in processing mode of 2-up, ID_{—}200-2 is set. The third program differs from the first program and second program in the method of expressing information specifying processing mode. For example, in the case of 2-up, specified value is set at 230-th byte position in the third program, while the specified value is set at 210-th byte position in the first program, and at 220-th byte position in the second program.

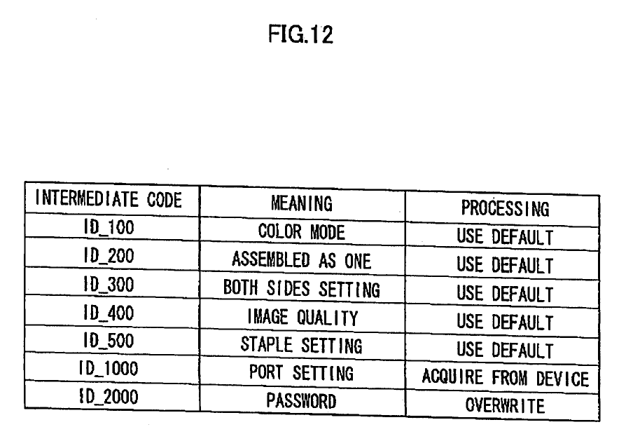

Thus, when seeing the original setting item of third program, for example, setting content is predetermined as shown in FIG. 12.

The analysis data (FIG. 11) is contained in the third program.

In this explanation, the first program covers to logical printers 110, 120 as shown below.

TABLE 1

| Logical printer name | Outline of settings |
|---|---|
| Logical printer 110 | Port A, monochromatic, 4-up, both sides, |
| | standard picture quality |
| Logical printer 120 | Port A, monochromatic, 1-up, one side, high |
| | picture quality, hand feed |

When the setting management method data of first program is converted and set for second program, two logical printers 210, 220 are created as follows.

TABLE 2

| Logical printer name | Outline of settings |
|---|---|
| Logical printer 210 | Monochromatic, 4-up, both sides, speed priority. |
| | password = “AAA” |
| Logical printer 220 | Monochromatic, 1-up, one side, quality priority, |
| | password = “AAA” |

In second program, as compared with first program, setting of picture quality and password is added. That is, the standard picture quality of logical printer 110 is set with speed priority in logical printer 210, and high pickle quality in logical printer 120 is set with quality priority in logical printer 220.

In this case, since the printer 200 is connected to the port to which the printer 100 has been connected instead of the printer 100, and the port setting is not changed. Logical printers 110, 120 are not necessary, logical printer names are not changed, and replaced by logical printers 210, 220.

In the second program, further, the third logical printer can be newly added as follows.

TABLE 3

| Logical printer name | Outline of settings |
|---|---|
| Logical printer 230 | Color, 2-up, both sides, standard picture quality, |
| | upper left staple |

By setting management method data of these three logical printers in second program, when another new printer is connected instead of printer 200, the following three logical printers 310, 320, 330 are created.

TABLE 4

| Logical printer name | Outline of settings |
|---|---|
| Logical printer 310 | Monochromatic, 4-up, both sides, standard picture |
| | quality, password = “AAA” |
| Logical printer 320 | Monochromatic, 1-up, one side, high picture |
| | quality, password = “AAA” |
| Logical printer 330 | Monochromatic, 2-up, both sides, standard picture |
| | quality, upper left staple |

In this case, when new printer connected in place of printer 200 is connected from other port, port setting is acquired from the corresponding new printer.

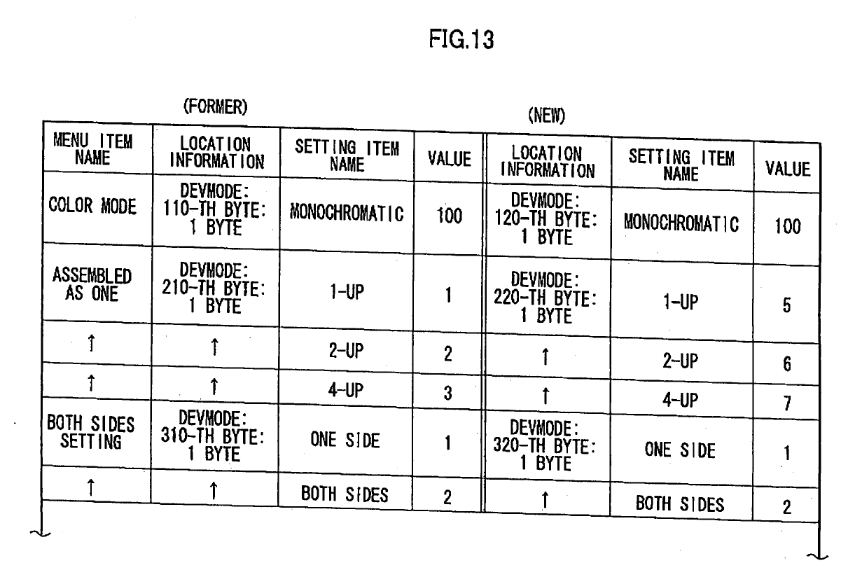

In this example, the setting management method data is changed by using the intermediate format code, but the invention is not limited to this example, but as shown in FIG. 13, conversion table (related information) corresponding to the setting management method data of common processing mode may be also used.

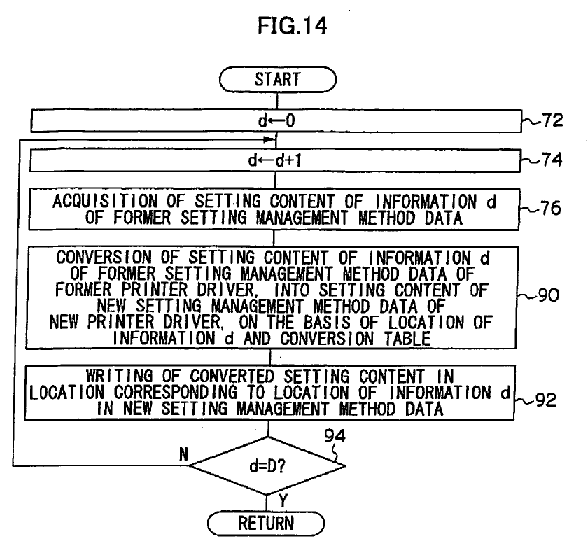

In this case, process at step 58 in FIG. 7 executes the process of FIG. 14, instead of the process of FIG. 8. That is, same as steps 72 to 76 in FIG. 8, steps 72 to 76 are executed, and at step 90, setting content of information d is converted to new setting management method data of new printer driver, by referring to the conversion table, on the basis of the position of information d of former setting management method data of former printer driver, and at step 92, the converted setting content is written into a position corresponding to position of information d in new setting management method data and at step 94, same process as step 86 in FIG. 8 is executed.

This is only an example, and the invention can be applied in various modified examples.

For example, the intermediate format code or conversion table is used, but the invention is not limited to them, but, for example, it may be designed to convert manually. This is realized by using, for example, means for detecting reflection of user interface to setting management method data (detection of data), or means for linking the reflection to setting management method data to the meaning of setting. Further, in these examples, meaning or content of setting content is judged, but ignoring the meaning or content, it may be managed only by correspondence of position.

When converting and setting the setting management method data in such manner, it is also possible to have managing means for managing the information of handing over and information not handing over to the setting information in second program from the information in first program. Information of handing over and information not banding over may specify, for example, whether the network setting is handed over or not from the former model. Or, the printer icon name (name of logical printer) is same as in former model or changed to new model. The printer icon for former model is deleted, or only renamed. Or it may be intended to manage the variation or default of handling having no correspondence or unknown setting, acknowledgment, prior setting, etc. Further, device information (information of process execution device) such as specific content of printer, position and number of trays and others may be acquired from the network, and proper values may be set, or proper values may be given beforehand.

In the explained example, start timing of processing mode specifying information conversion program in FIG. 7 is not specifically described, but actually the start timing may be the time instructed by the means for instructing either start of second program when or after installing the second program, or at the start of processing mode specifying information conversion program. The time instructed by the instructing means is the time of starting the processing mode specifying information conversion program by specifying, for example, the logical printers 110, 120 shown in FIG. 10 individually by using the mouse or the like. In this case, for example, after installing the logical printer 310 (see Table 4), a program same as processing mode specifying information conversion program shown in FIG. 7 is started from the user interface. In this case, process of steps 54, 56, 64 in FIG. 7 is omitted.

In this case, first, the logical printer 310 is installed in default state. Next, a specific button (for example, set copy button) of user interface of the logical printer 310 is pressed. As a result, all installed logical printers are listed up, and the logical printer 210 as setting copy origin is selected. By this processing, the logical printer 310 can be created same as in the above embodiment.

The logical printer 330 can be created from the logical printer 310. First, a specific button (for example, logical printer add button) of user interface of the logical printer 310 is pressed. As a result, all installed logical printers are listed up, and the logical printer 230 as setting copy origin is selected. Then the logical printer 330 is installed in default state, and the logical printer 330 is set by the same processing.

In this case, in the case of conversion from one logical printer, in a same model, it may be designed to create logical printer for new model corresponding to each one of printer icons (logical printers) of former model.

Not limited to management of plural printers of same model by one logical printer, one logical printer can be used in batch management of printers (plural different process execution devices) of one family, namely, plural different models.

The setting management method data in first program may be designated by the information of port for output of control data for setting of printing process of printer (route of output of data for executing the process by the process execution device, for example, IP address or port name), model name, model family, or icon name.

When converting or changing the setting management method data, in every new settings, the setting management method data may be written over the form a setting management method data, a logical printer may be newly created, or setting may be overwritten after exchanging the driver of existing logical printer.

Conversion or setting of setting management method data may be executed on the same documentation device, or via the network.

Conversion or setting of setting management method data is not limited to the processing of the client, but similar processing may be done by the printers (new printer, former printer).

As the setting management method data, an example of byte train is shown, but plain text, or text having XML stored may be also used.

In the shown examples, the first to the third programs are used to specify the processing mode of print process in the printer, but the invention is not limited to this operation. For example, the setting management method data in documentation program and spread sheet program can be converted. For example, the documentation program is first installed, and font and size of letters are set as processing mode, and when the spread sheet program is installed, information of processing mode (font and size of letter) set in the documentation program is converted and set for spread sheet program. In this case, each client corresponds to each process execution device.

What is clamed is:

1. A storage medium, on which a processing mode specifying information conversion program for causing a computer to execute processing mode specifying information conversion process is stored, wherein the processing mode specifying information conversion process includes
(a) acquiring first information for specifying a processing mode of a first process in a first program,
(b) converting the acquired first information into second information for specifying a processing mode of a second process in a second program, which is different from the first program in a method of expressing information for specifying a processing mode, and
(c) setting the converted second information.

2. The storage medium of claim 1, wherein, in (b), information is converted by using related information expressing a relation between the processing mode of the first process and the processing mode of the second process.

3. The storage medium of claim 2, wherein the related information is a conversion table expressing the relation between the processing mode of the first process and the processing mode of the second process, or identification information predetermined for a processing mode common to the processing mode of the first process and the processing mode of the second process.

4. The storage medium of claim 1, wherein start timing of the processing mode specifying information conversion process is any of a time when the second program is installed, a time when on instruction is given to start the second program after the installation thereof, or a time when an instruction is given by instructing unit that instructs the starting of the processing mode specifying information conversion process.

5. The storage medium of claim 1, wherein
the first information is present in a plurality, and
the processing mode specifying information conversion process is executed for every one of the first information.

6. The storage medium of claim 1, wherein a processing mode is specified for plural different process execution devices by the first information.

7. The storage medium of claim 1, wherein
the processing mode specifying information conversion process further includes (d) specifying respective pieces of plural pieces of the first information selectively, and
in (a), the first information specified in (d) is acquired.

8. The storage medium of claim 7, wherein
the processing mode specifying information conversion process further includes
(e) displaying identification information for identifying respective pieces of plural pieces of the first information, and
in (d), the plural pieces of the first information are selectively specified by selectively specifying the identification information for identifying respective pieces of the plural pieces of the displayed first information.

9. The storage medium of claim 1, wherein
the location for storing the second information is predetermined, and
in (c), the converted second information is set by storing the converted second information in the predetermined location.

10. The storage medium of claim 1, wherein
the processing mode specifying information conversion process further includes
(f) managing at least one of a route of output of data for causing the process execution device to execute the process, identification information for identifying the first information and the second information, and information of the process execution device.

11. The storage medium of claim 1, wherein the first process and the second process are printing processes, or, one of the first process and the second process is a document creating process for creating a document, and the other is a spreadsheet process.

12. A storage medium, on which a processing mode specifying information conversion program for causing a computer to execute a processing mode specifying information conversion process is stored, wherein
the processing mode specifying information conversion process includes
(a) acquiring first information for specifying respective plural processing modes of a first printing process in a first printer driver program,
(b) converting the acquired first information into second information for specifying a processing mode of a second printing process in a second printer driver program, which is different from the first printer driver program in a method of expressing information for specifying a processing mode, and
(c) setting the converted second information.

13. An information processing apparatus connected to a process execution device and having a storage medium, wherein
the storage medium stores a processing mode specifying information conversion program for causing a computer to execute a processing mode specifying information conversion process, and
the processing mode specifying information conversion process includes
(a) acquiring first information for specifying a processing mode of a first process in a first program by acquiring means,
(b) converting the acquired first information into second information for specifying a processing mode of a second process in a second program, which is different from the first program in a method of expressing information for specifying a processing mode, by converting means, and
(c) setting the converted second information by setting means.

14. The information processing apparatus of claim 13, wherein the information processing apparatus is a document creating apparatus.

15. An information processing apparatus connected to a process execution device and having a storage medium, wherein
the storage medium stores a processing mode specifying information conversion program for causing a computer to execute a processing mode specifying information conversion process, and
the processing mode specifying information conversion process includes
(a) acquiring first information for specifying respective plural processing modes of a first printing process in a first printer driver program by acquiring means,
(b) converting the acquired first information into second information for specifying a processing mode of a second printing process in a second printer driver program, which is different from the first printer driver program in a method of expressing information for specifying processing mode, by convening means, and
(c) setting the converted second information by setting means.

16. The information processing apparatus of claim 15, wherein the information processing apparatus is a document creating apparatus.

17. A process execution device having a storage medium, wherein
the storage medium stores a processing mode specifying information conversion program for causing a computer to execute a processing mode specifying information conversion process, and
the processing mode specifying information conversion process includes
(a) acquiring it information for specifying respective plural processing modes of a first printing process in a first printer driver program by acquiring means,
(b) converting the acquired fit information into second information for specifying a processing mode of a second printing process in a second printer driver program, which is different from the first printer driver program in a method of expressing information for specifying a processing mode, by converting means, and
(c) setting the converted second information by setting means.

18. A processing mode specifying information conversion method comprising
acquiring first information for specifying a processing mode of a first process in a first program;
converting the acquire first information into second information for specifying a processing mode of a second process in a second program, which is different from the first program in a method of expressing information for specifying a processing mode; and
setting the converted second information.

19. A processing mode specifying information conversion method comprising
acquiring first information for specifying respective plural processing modes of a first painting process in a first printer driver program;
converting the acquired first information into second information for specifying a processing mode of a second printing process in a second printer driver program, which is different from the first printer driver program in a method of expressing information for specifying a processing mode; and
setting the converted second information.
